(19) United States
(12) Patent Application Publication
(10) Pub. No.: US 2012/0099425 A1
(43) Pub. Date: Apr. 26, 2012

(54) NETWORK DEVICE AND METHOD FOR ESTABLISHING PATH DATA

(76) Inventors: Ran-Yih WANG, Taipei City (TW); Fuh-Jang LIN, Hsinchu City (TW)

(21) Appl. No.: 13/281,219

(22) Filed: Oct. 25, 2011

(30) Foreign Application Priority Data
Oct. 26, 2010 (TW) 099136539

(51) Int. Cl. G06F 11/00

(52) U.S. Cl. 370/225

(57) ABSTRACT

A network device and a method for establishing path data are provided, the network device is connected to a network to receive and send a signal, and records a MAC table data and a ring port table data. The MAC table data comprises at least one path data. Each path data includes a device MAC address information and a first identification. When a path of the network is interrupted, the network device adjusts a second identification of ring port information of the ring port table data. The ring port information is corresponding to the network. When the network device obtains a data frame, a destination path data matched with the data frame is obtained from the MAC table data, and a first identification corresponding to a connection port of the destination path data is compared with the second identification to decide an output port for the data frame.

### CROSS-REFERENCE TO RELATED APPLICATION

This application claims the benefit of Taiwan Patent Application No. 099136539, filed on Oct. 26, 2010, which is hereby incorporated by reference for all purposes as if fully set forth herein.

### BACKGROUND OF THE INVENTION

1. Field of Invention

The present invention relates to a network device, and more particularly to a network device and a method thereof capable of quickly establishing path data when any one path is interrupted.

2. Related Art

The current ring topology architecture is a network architecture formed of a plurality of network devices and having a ring connection state. In the network architecture, the Ethernet Automatic Protection Switching (EAPS) protocol is mainly adopted to ensure that a data frame can be successfully transferred to a destination when one of the network devices is disconnected. According to the EAPS protocol, a network manager first chooses one of the network devices as a primary network device and the rest of network devices are transmission network devices, and a primary port and a secondary port are set in two ring ports of each network device respectively. The primary network device periodically sends out a detection data frame through the primary port, while the secondary port detects whether the detection data frame is received to denote that the transmission of a network with an architecture of ring type is successful or not. If yes, the secondary port is locked to reject reception of a non-specified data frame, so as to avoid transfer loop caused during subsequent data frame transfer. According to the EAPS protocol, each network device fixedly transfers the data frame to a next network device through the primary port. However, because the data frame is delivered in a single direction, a transfer path of the data frame may be lengthened in some circumstances. As shown in FIG. 1, when a first electronic device 210 needs to establish a conununication transmission with a second electronic device 220, an optimal transmission path would be the path that passes through a second network device 120, a first network device 110, and a sixth network device 160, and the second electronic device 220 will be reached finally. However, the EAPS protocol will let the transmission path pass through the second network device 120, a third network device 130, a fourth network device 140, a fifth network device 150, the sixth network device 160, and the second electronic device 220, so that an amount of network devices through which data frame transmitted between the first electronic device 210 and the second electronic device 220 would be increased. In this way, in addition to the increase of the transmission time, the transmission bandwidth of each network device through which the data frame transmission passes is further occupied so the traffic efficiency of the entire network is affected. Additionally, according to the EAPS protocol, when an error occurs to a ring port of a certain network device (such as disconnection), the network device sends an error notification to other network devices, or when the primary network device does not receive the detected packets for a period of time, the primary network device notifies all network devices to completely delete the path data relevant to this network in the MAC table data and then to reestablish new path data. However, because the delivery of the data frame requires that the reestablishment of the path data is completed first, for some services in need of higher requirement of fluent transfer, such as a network telephone or a video service, fluency of data frame transmission is influenced.

Therefore, how to select a shortest path for transferring the data frame in the network during data frame delivery, and how to quickly and accurately transfer data frame if an interruption occurs in the network device are the main topics to be achieved for network devices.

### SUMMARY OF THE INVENTION

The present invention provides a network device and a method thereof, which have a path selection capability and are capable of establishing path data more quickly when a path is changed.

In order to solve the device problem, the present invention discloses a network device for establishing path data, which includes a memory unit and a processing unit.

The memory unit is recorded with a MAC table data and a ring port table data. The MAC table data includes at least one path data, and each path data includes a device MAC address information and a first identification. The ring port table data comprises a ring port information corresponding to a network. The ring port information comprises a ring port number, information of a primary port and information of a secondary port corresponding to the ring port number and connected to the network, and a second identification.

The processing unit is used to adjust the corresponding second identification when path interruption of the network is detected, and analyzes whether the first identification of destination path data of the data frame is consistent with the second identification corresponding to the destination path data when receiving the data frame, so as to decide an output port for the data frame.

In a network device for establishing path data according to the present invention, each ring port information further includes a port status value corresponding to a connection status of the network, and when a path of the network is interrupted, the processing unit changes the port status value from a ring network value to a line network value and adjusts the second identification.

The network device for establishing path data according to the present invention is recorded with a total hop count value, which can be set by software; the each path data further includes a hop count value corresponding to the device MAC address information.

When obtaining the data frame, the processing unit decides the output port for the data frame according to whether the hop count value of the data frame reaches or exceeds half of the total hop count value.

In order to solve the above method problem, the present invention discloses a method for establishing path data of a network device. This network device is connected to a network with an architecture of ring type for receiving and sending a data frame, and the method includes: establishing a MAC table data and a ring port table data, in which the MAC table data includes at least one path data, each path data includes a device MAC address information and a first identification, and the ring port table data includes a ring port information, which comprises a second identification; and when the network is interrupted after a judgment, whether the first identification of destination path data of the data frame is consistent with the corresponding second identification is analyzed, so as to decide an output port for the data frame.

The method for establishing path data of the network device according to the present invention includes: when the network is not interrupted, the hop count value corresponding to the destination MAC address information is obtained according to the device MAC address information of the each path data corresponding to a destination MAC address information of the data frame; whether the hop count value reaches or exceeds half of the total hop count value is judged; when the hop count value does not reach or exceed half of the total hop count value, the data frame is forwarded from a primary port corresponding to the ring port number matched with the destination path data; and otherwise, the data frame is forwarded from the secondary port corresponding to the ring port number of the destination path data.

The present invention is characterized in that, when that a path is interrupted in a network is judged, any network device is immediately to adjust a second identification corresponding to a ring port table data corresponding to the network, so that in a subsequent data frame forwarding process, an output port for data frame transfer should be quickly judged through a comparison result between a relevant first identification and a relevant second identification, so as to forward the data frame to a destination network device quickly and accurately. Therefore, when the path data is established, the present invention first ensures a transfer capability between a network device and other equipments, so as to avoid data loss due to path interruption. Next, according to the present invention, through calculation and comparison of a hop count value and a total hop count value, the network device can quickly reselect a transmission path with less path cost, so as to increase the communication efficiency and a data transmission rate among network devices.

### BRIEF DESCRIPTION OF THE DRAWINGS

The present invention will become more fully understood from the detailed description given herein below for illustration only, and thus are not limitative of the present invention, and wherein:

FIG. 1 is a schematic view of data frame transmission of a ring routing protocol in the prior art;

FIG. 2 is a schematic structural view of a network device according to an embodiment of the present invention;

FIG. 3 is a schematic view of data frame transmission between a first electronic device and a second electronic device according to an embodiment of the present invention;

FIG. 4 is a schematic view of network interruption according to an embodiment of the present invention;

FIG. 5 depicts a method for establishing path data of a network device according to an embodiment of the present invention;

FIG. 6 is a schematic view of a path switching determination process according to an embodiment of the present invention;

FIG. 7 is a flow chart of hop count value determination according to an embodiment of the present invention;

FIG. 8 is a detailed flow chart according to an embodiment of the present invention;

and

FIG. 9 is a flow chart of MAC table data update according to an embodiment of the present invention.

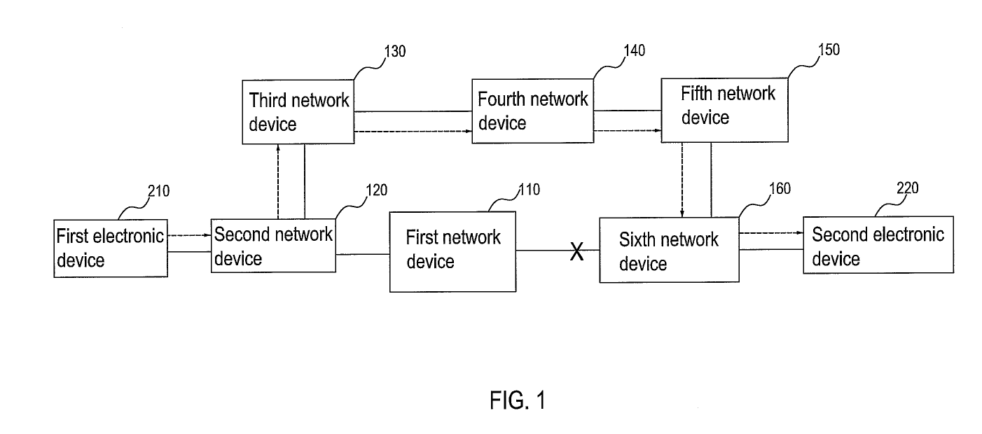

### DETAILED DESCRIPTION OF THE INVENTION

Preferred embodiments of the present invention are illustrated with reference to the accompanying drawings as follows.

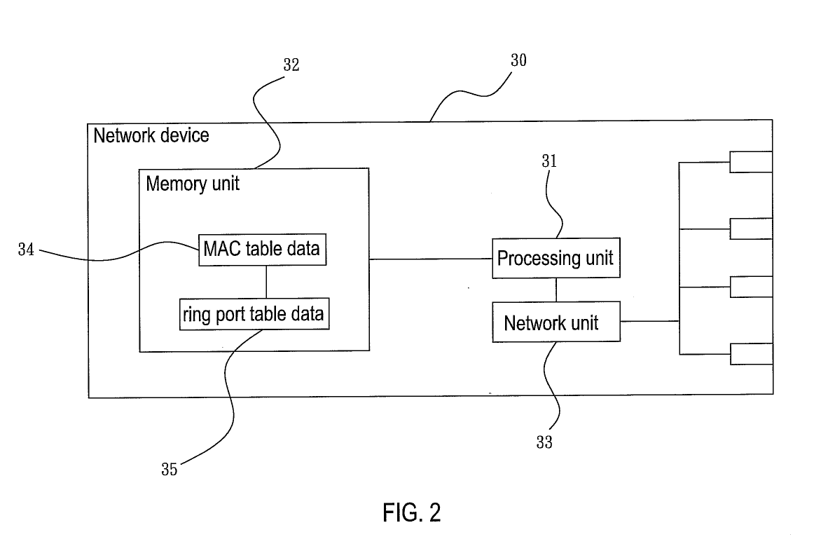

First, FIG. 2 is a schematic structural view of a network device according to an embodiment of the present invention.

Referring to FIG. 2, a network device 30 includes a network unit 33, a memory unit 32, and a processing unit 31. The network unit 33 is used to receive and send a data frame, and includes multiple connection ports used to serve as output/input interfaces for receiving and sending the data frame. The memory unit 32 is used to store a MAC (Lookup) table data 34 and a ring port table data 35. The processing unit 31 is electrically connected to the memory unit 32 and the network unit 33, so as to read the MAC table data 34 and the ring port table data 35 to process the data frame transmitted by the network unit 33.

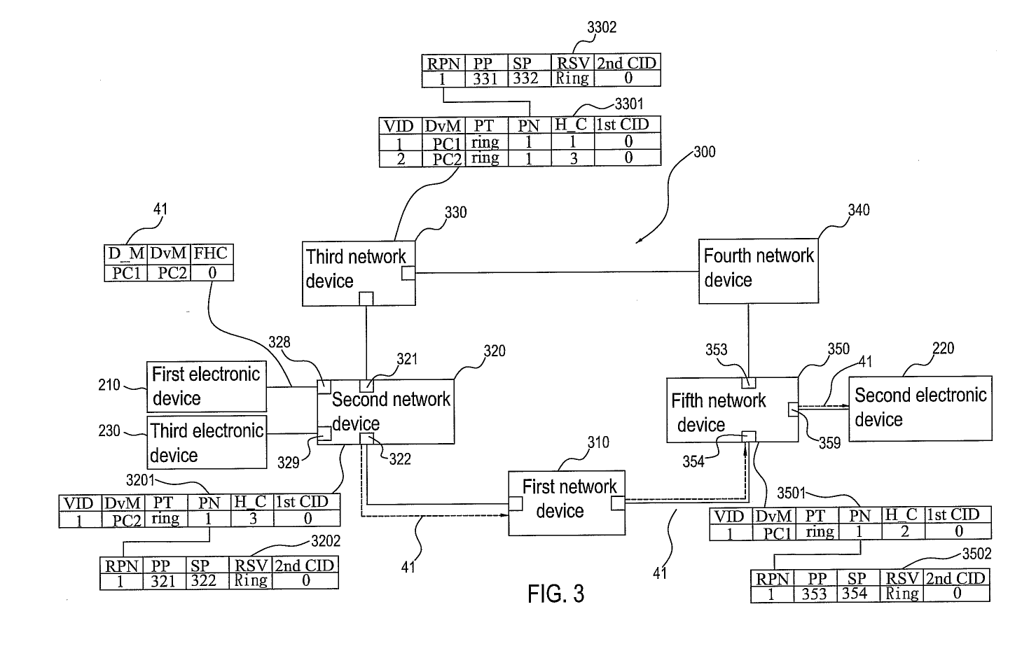

Referring to FIG. 3, an architecture of a network system according to an embodiment of the present invention is shown. The network 300 is formed by connecting a plurality of the network devices 30 (which is illustrated hereinafter through a first network device 310, a second network device 320, a third network device 330, a fourth network device 340, and a fifth network device 350) to each other, and each network device establishes its own MAC table data 34 through a data frame delivery procedure respectively. In the embodiment of the present invention, a network device is preferably an Ethernet switch, and a ring port table data 35 thereof is preset by a network manager according to configuration among the network devices in the network system, but the present invention is not limited thereto.

A ring port table data (a format like 3202 and 3302 as shown in FIG. 3) comprises ring port information of the network devices for forming the network system. The ring port information includes an Ring Port Number (for example, an RPN field in FIG. 3) and information of a primary port (for example, a PP field in the drawing), and information of a secondary port (for example, an SP field in FIG. 3) which are corresponding to the ring port number and connected to the network, a ring port status value (Ring Status Value, for example, an RSV field in FIG. 3), and a second identification (such as a 2nd CID field in FIG. 3). The first identification is the same as an initial value of the second identification. It is additionally noted that, port status value in the embodiment of the present invention include two types, one is a ring network value (which is represented with a “ring” in the embodiment of the present invention), and the other is a linear network value (which is represented with a “line” in the embodiment of the present invention). When ring ports of network devices are successfully connected to form the network 300, the port status value is set as a ring network value; otherwise, it is set as a line network value. The numbers of primary port and the secondary port in the ring port table data are used to link secondary ports and primary ports of other network devices in the system respectively. In the embodiment of the present invention, it is preset that, the primary port serves as a preset port for fixedly sending the data frame. When the primary port fails or the primary port is a source connection port for receiving the data frame, the data frame is output through the secondary port, and only persons skilled in the art can change a preset port for sending depending on a situation thereof

MAC table data (for example, 3201, 3301, and 3501 as shown in FIG. 3) of network devices, each MAC table data comprises a path data of receiving the data frame. The path data includes the following data.

(1) A device MAC address information (referred to as DvM for short for the field in the following drawings) is obtained from a source MAC field (S_M in a field in the following drawing) of the received data frame, and a source MAC address information of the data frame represents device MAC address information of sending the data frame.

(2) A connection port type (referred to as PT for sort for the field in the following drawings) is a type of a connection port for receiving the data frame, which comprises information of a connection port mode for receiving the data frame. In the embodiment of the present invention, the connection port type includes two types: one is a ring port type applied to the network, and the other is a non-ring port type; and the non-ring port type further includes a trunk port type and a physical port type.

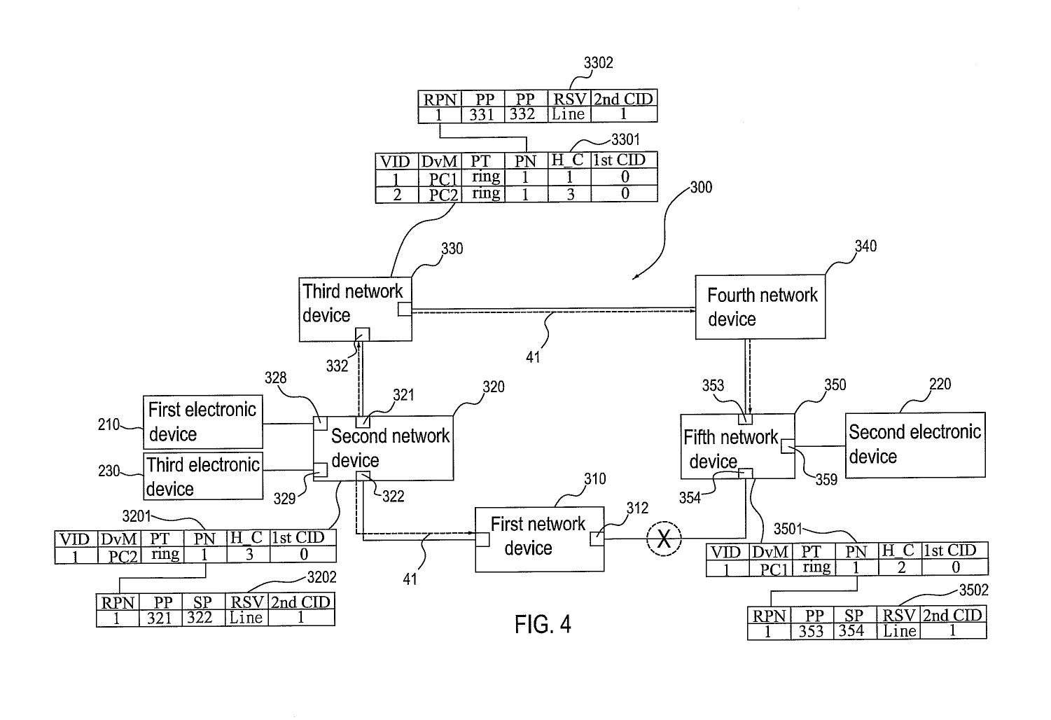

(3) A connection port number (referred to as PN for short for the fields depicted in the following FIGS. 3 and 4) is the number of a connection port for receiving the data frame.

(4) A first identification (such as a 1st CID field in FIG. 3) is used to be compared with the second identification, so as to decide how to send the data frame. An initial value of the first identification is obtained from the second identification corresponding to the ring port number in the ring port table data corresponding to the received connection port at the time of receiving the data frame. The first identification is a value being set to the same as the second identification in the ring port table data 35 at the time in a learning procedure of the network device. More specifically, when any one network device 30 is learning MAC address information of a data frame, if a connection port type of a source connection port of the data frame is the ring port, based on the value of the second identification corresponding to the ring port in the ring port table data currently, the same value is included in the MAC table data to correspond to the first identification of the path data. As shown in FIG. 3, it is known from the MAC table data 3201 stored by the second network device 320 that, the second network device 320 forms a part of the network 300 through connection of a connection port 321 and a connection port 332 of the third network device 330. The ring port table data 3202 of the second network device 320 comprises the primary port and the secondary port with the ring port number of 1 to be the connection port 321 and the connection port 322 respectively, and the corresponding second identification is 0, so when the second network device 320 is learning data of the data frame received from the third network device 330, the value (0) of the second identification is written into the first identification (also be 0).

(5) A hop count value (referred to as hop count value for short for the field in the following drawings) refers to the number of hops between the source network device sending the data frame and its own network device (that is, how many network devices are required for forwarding at the time of reaching the destination network device). This hop count value is learnt by each network device from a frame hop count value (FHC) field in the data frame at the time of obtaining the data frame. It is illustrated herein that, the frame hop count value is an accumulated value that a value in the frame hop count value field of the data frame is added by one when each network device obtains a data frame and determines to forward the data frame. For example, when the second network device 320 transmits a data frame 41 to the fifth network device 350, the shortest path should be a path passing through the second network device 320, the first network device 310, and the fifth network device 350, that is, passing through two network devices. Furthermore, for a quantity of network devices through which the data frame 41 practically passes, a network device for forwarding the data frame continuously updates an frame hop count value of the data frame 41, and finally, the fifth network device 350 reads and records the frame hop count value in its own MAC table data. As depicted in FIG. 3, in the MAC table data 3501 of the fifth network device 350, a path data comprises virtual local area network (VLAN) ID (VID): 1; a device MAC address information as a device MAC address information (referred to as PC1 in FIG. 3) of the first electronic device 210; a connection port number(PN): 1; and an H_C: 2.

(6) A virtual local area network ID (VLAN ID, referred to as VID in a field in the following drawings).

As shown in FIG. 3, a manner of data frame transmission between the first electronic device 210 and the second electronic device 220 according to an embodiment of the present invention is illustrated hereinafter.

In the network 300 depicted in FIG. 3, the second network device 320 is connected to the first electronic device 210 through a connection port 328, and is connected to the network 300 through two connection ports (321 and 322), and the connection ports (321 and 322) and ring port number thereof are preset in the ring port table data 3202 of the second network device 320; the fifth network device 350 is connected to the second electronic device 220 through a connection port 359, and is connected to the network 300 through two connection ports (353 and 354), and the connection ports (353 and 354) and ring port number thereof are preset in the ring port table data 3502 of the fifth network device 350. In addition, all network devices are preset with a total hop count value, which represents an amount of network devices of the network 300 and an upper limit number of forwarding the data frame, and an amount of 5 is used as an example herein.

In this embodiment, the MAC table data 3201 of the second network device 320 comprises a path data relevant to transmission data of the second electronic device 220, which includes: (1) a VID: 1; (2) a DvM: PC2, that is, a device MAC address information of the second electronic device 220; (3) a PT: a ring port; (4) a connection port number(PN): 1, corresponding to ring port number: 1 of the ring port table data 3202, that is, the corresponding connection ports (321 and 322), where the connection port 321 is a primary port, and the connection port 322 is a secondary port; (5) an H_C: 3; and (6) a 1st CID: 0.

When the second network device 320 obtains the data frame 41 with a destination MAC address information of the second electronic device 220, first a learning process is performed on the data frame 41. It is illustrated herein that, data frame formats used in the following embodiment are as depicted in FIG. 3, and include: (1) a destination MAC address information (referred to as D_M for short in the drawings), which is a device MAC address information of a destination device; (2) a source MAC address information (S_M in the drawing), which refers to a device MAC address information of sending the data frame 41; (3) a frame hop count value (the FHC in the drawing), which is a number by which the data frame 41 is practically forwarded.

Next, the second network device 320 compares the destination MAC address information of the data frame 41 with a device MAC address information of each path data in the MAC table data 3201, so as to judge whether a destination path data conforming to the destination MAC address information exists in the MAC table data 3201. If the destination path data does not exist in the MAC table data 3201, the second network device 320 floods the data frame 41 out through various connection ports. It is worth mentioning that, if a connection port is a ring port and a port status value is a ring network value, the data frame 41 only needs to be sent out through a preset port, either the primary port or the secondary port, for example. If the port status value is a line network value, both the primary port and the secondary port send the data frame.

Otherwise, when the path data corresponding to the device MAC address information exists in the MAC table data, the data frame is sent through a specified connection port according to the path data in the MAC table data. Types of connection ports for receiving the data frame and types of connection ports specified for outputting should have the following several cases: (1) Input through a non-ring port, and output through a ring port; (2) input through a non-ring port, and output through a non-ring port; (3) input through a ring port, and output through a non-ring port; and (4) input through a ring port, and output through a ring port. However, these data frame receiving and sending modes are recited hereinafter.

In this embodiment, the second network device 320 is illustrated in the first case. The second network device 320 obtains the data frame 41 from the first electronic device 210 through the connection port 328, and the second network device 320 decides to transfer path data with the number of 1 of the destination path data of the data frame 41. The transferred port type is a ring port, and a connection port number thereof is 1. Therefore, the second network device 320 then finds out port data with the ring port number of 1 from the ring port table data 3202, and decides that this data frame 41 is forwarded by the connection port 321 (the primary port) or the connection port 322 (the secondary port). In an embodiment of the present invention, the primary port of the ring port is preset as a connection port for sending. In another embodiment, the secondary port of the ring port is preset as the connection port for sending. Next, the second network device 320 finds out that a port status value of the port data of the ring port number of 1 is a ring network value or a line network value, so as to determine whether the network 300 has a ring shape, or any one path thereof is interrupted to form a linear network. It is noted that, a purpose of judging a network port status value by a network device lies in that, when the network has a ring shape, the data frame is sent through a preset port; if the network becomes linear, the data frame is sent through both the primary port and the secondary port. Therefore, when the port status value becomes linear from a ring shape, representing a case that the network is interrupted, the data frame is ensured to be quickly and accurately transmitted to the destination network device.

It is additionally mentioned that, when the data frame enters the connection port having the ring port type from the connection port having the non-ring port type, the network device needs to add an frame hop count value field in this data frame, an initial value thereof is preset to 1, while at the time of finally reaching the destination MAC address information, the network device receiving the data frame 41 needs to remove the frame hop count value field of this data frame, which is also similar to the network header data.

However, when deciding to transfer the destination path data of the data frame 41, the second network device 320 first analyzes whether the transferred port type is a ring port, and if yes, judges that this data frame 41 is forwarded through the connection port 321 (the primary port) or the connection port 322 (the secondary port). A judgment manner is as follows. According to an hop count value of the destination path data, it is judged whether a value thereof reaches or exceeds half of a total hop count value, so as to decide whether the data frame 41 is forwarded through the preset primary port 321 or the secondary port 322.

For example, the MAC table data of the second network device 320 is as depicted in FIG. 3, and the data frame 41 sent by the first electronic device 210 points to the second electronic device 220. The second network device 320 obtains a destination path data from the MAC table data 3201, and the destination path data is a VID: 1; a DvM: PC2; a PT: a ring port; a connection port number(PN): 1; and an H_C: 3. Next, from the ring port table data 3202, the second network device 320 learns that an RPN: 1; a corresponding port status value thereof: a ring network value; the primary port: the connection port 321; and the secondary port: the ring port 322.

The second network device 320 analyzes that no path is interrupted in the current the network 300, and the data frame 41 should be forwarded by the connection port 321 (the primary port). The path switching mode is applicable when an electronic device connected to any network device is sending a data frame, and the present invention is not limited thereto.

FIG. 4 is a schematic view of network interruption according to an embodiment of the present invention. In this embodiment, path interruption between a first network device 310 and a fifth network device 350 is described as an example.

As shown in FIG. 4, it is assumed that the first network device 310 judges that a ring port 312 thereof is abnormal causing connection path interruption, so the first network device 310 informs other network devices of a message of the path interruption, each network device receiving the message modifies a port status value of its own ring port table data to a line network value from a ring network value, and meanwhile changes a second identification of the port data corresponding to this network. In this embodiment, each network device adds 1 to the second identification corresponding to this network 300. As shown in FIG. 4, in a ring port table data 3202 of a second network device 320, an ring port number of the port data corresponding to this network 300 is 1, and the second identification included by the port data becomes 1 from 0. It is worth mentioning that, a manner of changing the second identification can be any operation manner. For example, the original second identification is changed in a manner of adding, subtracting, multiplying, and dividing a constant.

When obtaining the data frame 41 as shown in FIG. 3 or other types of data frame from the first electronic device 210 through a connection port 328, the second network device 320 finds out destination path data conforming to the destination MAC of the data frame from the MAC table data 3201, obtains the second identification from the corresponding port data in the ring port table data 3202, and compares a first identification of the destination MAC address information with the second identification of the port data to determine whether they are equal or not. If yes, the data frame is sent according to the destination path data in the MAC table data; otherwise, the data frame 41 is sent out through each connection port in a flooding manner.

For example, it is assumed that the second network device 320 obtains the data frame 41 pointing to the second electronic device 220, and judges that the destination path data pointing to the second electronic device 220 includes a VID: 1; a DvM: PC2; a connection PT: a ring port; a connection port number(PN): 1; an H_C: 3; and a 1st CID: 0.

Next, from the ring port table data 3202, the second network device 320 learns that for an RPN: 1, a corresponding primary port thereof is a connection port 321, and a secondary port is a connection port 322; a second identification of the corresponding “RPN: 1” is 1.

The second network device 320 determines that the read first identification is not equal to the second identification, so the second network device 320 utilizes the connection port 321 and the connection port 322 to send the data frame 41 in the flooding manner. After being received by each network device, the data frame 41 is forwarded or discarded. However, when receiving, each network device analyzes the data frame 41, so as to record the path data with minimal path cost between the first electronic device 210 and each network device again. However, when the path data to be updated already exists in the MAC table data, the second network device 320 directly replaces the original data with a new first identification and other relevant data on the basis of the original path data. In this way, each network device can reestablish mutually connected communication paths in a short time, while the original path data without being updated is deleted one by one in cooperation with practical working demand of a network device depending on the consideration of a designer, or a deletion regulation is formulated, so that the network device clears the original path data according to the deletion regulation.

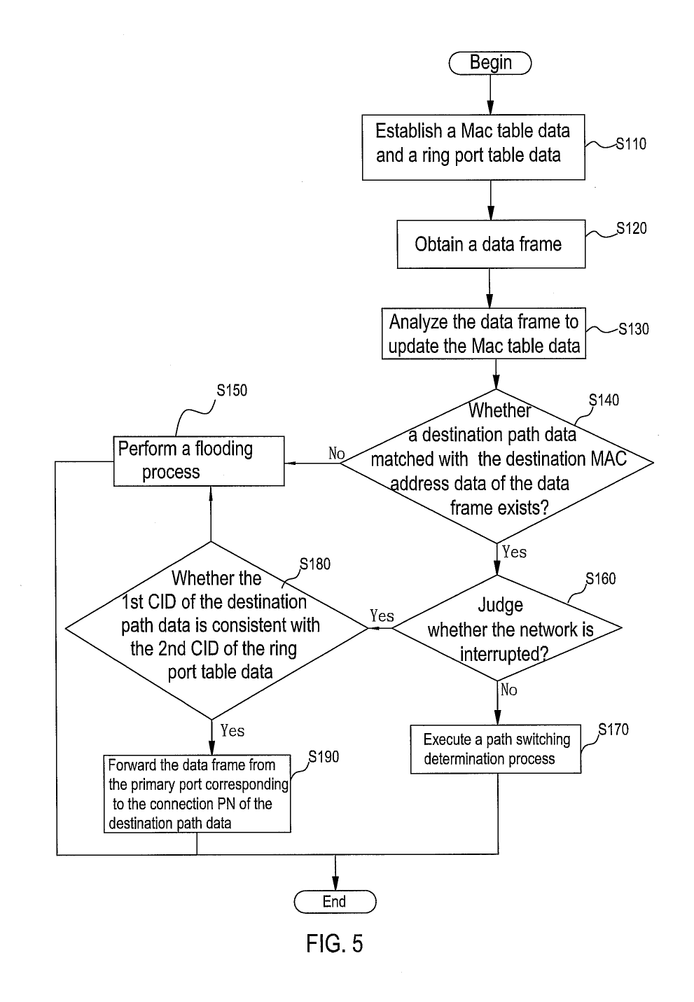

FIG. 5 depicts a method for establishing path data of a network device according to an embodiment of the present invention, which is better understood with reference to FIG. 2 together with FIG. 4. This method illustrates a path establishment process of each network device, and the process is illustrated as follows.

A MAC table data and a ring port table data are established (Step S110). As depicted in FIGS. 3 and 4, each network device learns MAC address information of interactively transmitted data frames through mutual communication (such as a flooding process) to establish its own MAC table data respectively, while ring port table datas (for example, 3201 and 3301 as depicted in FIGS. 3 and 4) are preset in each network device by a network operator.

A data frame is obtained (Step S120). Taking FIG. 3 as an example, the second network device 320 obtains the data frame 41 pointing to the second electronic device 220. The data frame 41 is obtained through the following two types of connection ports: (1) obtained through the connection port 328 or the connection port 329 of a physical port type; (2) obtained through the connection port 321 or the connection port 322 of a ring port type, that is, obtained by the first network device 310 or the third network device 330.

The data frame is analyzed to update the MAC table data (Step S130). This Step is a step that the second network device 320 performs a learning process (illustrated hereinafter) on the data frame 41.

The MAC table data is analyzed to determine whether a destination path data matched with the destination MAC address information of the data frame exists (Step S140). For example, in FIG. 3, the second network device 320 compares the destination MAC address information of the data frame 41 with a device MAC address information of each path data in the MAC table data 3201, so as to judge whether a destination path data corresponding to the destination MAC address information exists in the MAC table data 3201, and the judgment is based on whether the device MAC address information of the MAC table data 3201 conforms to the destination MAC address information.

When it is judged that no destination path data exists, a flooding process is performed (Step S150). As shown in FIG. 3, the second network device 320 floods the data frame 41 through various connection ports. If a connection port is the ring port type and a port status value is a ring network value, the data frame 41 is only sent through a preset port, either the primary port or the secondary port. If the port status value is a line network value, the data frame is sent through both the primary port and the secondary port, so as to perform the flooding process.

When it is judged that destination path data exists and conforms to the ring port type, that is, to judge whether the network 300 is interrupted (Step S160), and a judgment manner is to analyze whether a port status value included in the destination path data is a network value. For example, in FIG. 3, the second network device 320 obtains the data frame 41 from the first electronic device 210 through the connection port 328, and the second network device 320 analyzes path data with the number of 1 of required destination path data, and learns that the path data with the number of 1 conforms to the ring port type from a connection port type thereof. However, a connection port number of this path data is 1, so the second network device 320 finds out port data with the ring port number of 1 from the ring port table data 3202, so as to learn that this data frame 41 needs to be forwarded through the connection port 321 (the primary port) or the connection port 322 (the secondary port). Next, the second network device 320 finds out that a port status value of the port data of the ring port number of 1 is a network value or a line network value, so as to determine whether the network 300 has a ring shape, or any one path thereof is interrupted to form a linear network.

When it is judged that the network 300 is not interrupted, a path switching determination process is executed (Step S170). For example, in FIG. 3, the second network device 320 calculates an hop count value of the destination path data, and judges whether a value thereof reaches or exceeds half of a total hop count value, so as to decide whether the data frame 41 is forwarded through the preset primary port (the connection port 321) or the secondary port (the connection port 322).

When it is judged that the network 300 is interrupted, it is analyzed whether the first identification(1st CID) of the destination path data of the data frame 41 is consistent with the second identification(2nd CID) corresponding to the ring port number matched with the connection port number of the destination path data (Step S180).

For example, in FIG. 4, it is assumed that the first network device 310 judges that the connection port 312 thereof is abnormal causing connection path interruption, the first network device 310 informs other network devices of a message of the path interruption. Each network device immediately modifies a port status value of its own ring port table data to a line network value, and meanwhile changes a second identification included in the port data corresponding to this network. For example, each network device adds 1 to the second identification corresponding to this network 300. As shown in FIG. 4, in the ring port table data 3202 of the second network device 320, the ring port number of the port data corresponding to this network 300 is 1, and the second identification included in the port data becomes 1 from 0.

Therefore, in Step S160, from the ring port table data 3202, the second network device 320 learns that the port status value of the port data of the ring port number of 1 is a line network value, so as to determine that the network 300 to which the connection port 321 and the connection port 322 are connected forms a linear network.

Then, in Step S180, the second network device 320 finds out destination path data conforming to the destination MAC address information of the data frame 41 from the MAC table data 3201, analyzes the ring port number corresponding to the destination path data from the ring port table data 3202, compares the connection port number with the ring port number having the same port No., and determines whether the first identification and the second identification corresponding to the both respectively are equal, so as to decide whether to perform the flooding process.

When it is judged that the first identification is not consistent with the second identification, a flooding process is performed (Step S150).

Otherwise, when the first identification is consistent with the second identification, the data frame is forwarded through the primary port corresponding to the connection port number of the destination path data (Step S190).

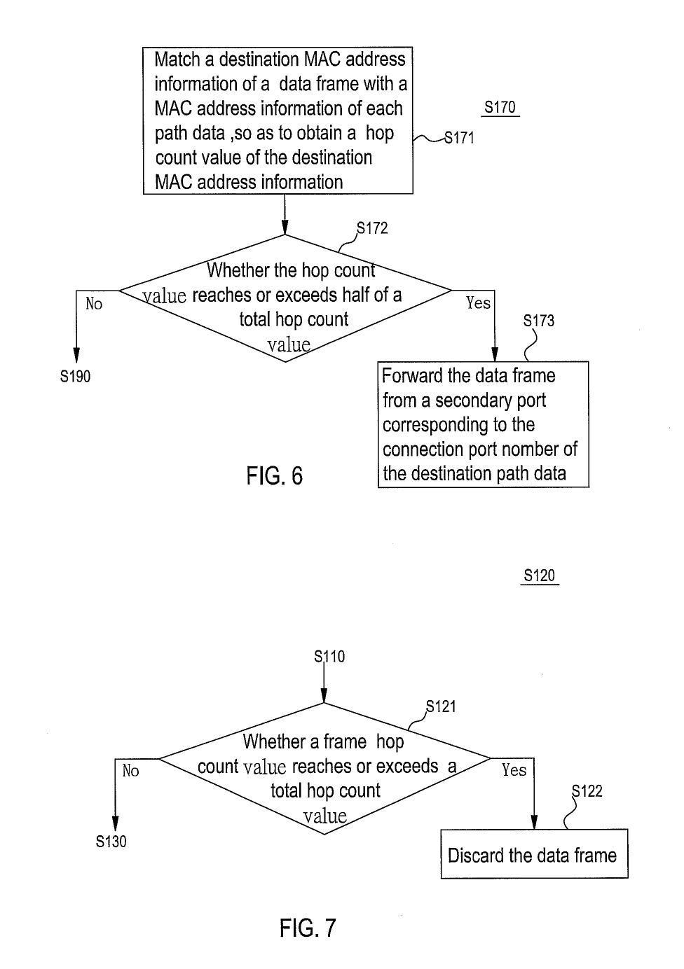

FIG. 6 is a schematic view of a path switching determination process according to an embodiment of the present invention, which includes the following steps.

A destination MAC address information of a data frame is matched with a device MAC address information of each path data, so as to obtain an hop count value of the destination MAC address information (Step S171).

It is calculated whether the hop count value reaches or exceeds half of a total hop count value (Step S172).

When it is judged that the hop count value does not reach or exceed half of the total hop count value, the data frame is forwarded through a primary port corresponding to a connection port number of destination path data (Step S190).

Otherwise, when it is judged that the hop count value reaches or exceeds half of the total hop count value, the data frame is forwarded through a secondary port corresponding to the connection port number of the destination path data (Step S173).

The second network device 320 analyzes that no path is interrupted in the current network 300, and the data frame 41 should be forwarded through the connection port 321 (the primary port). Next, the second network device 320 obtains the hop count value of 3, which reaches or exceeds half of the total hop count value, that is, 5/2=2.5. Therefore, the second network device 320 determines not to forward the data frame 41 through the connection port 321 (the primary port), and instead, forward the data frame 41 onto the network 300 through the connection port 322 (the secondary port) matched with the ring port 321. However, the half of the total hop count value can be a preset value calculated and obtained by each network device in advance, or a set value input by a network operator in advance.

Otherwise, when the hop count value of the destination path data is below 2, the second network device 320 judges that this hop count value is lower than half of the total hop count value, that is, 5/2=2.5. Therefore, the second network device 320 determines to forward the data frame 41 onto the network 300 from the connection port 321 (the primary port).

Referring to FIG. 7 at the same time, FIG. 7 is a flow chart of hop count value determination according to an embodiment of the present invention, and illustrates that Step S120 further includes the following steps.

It is judged whether an frame hop count value of the data frame reaches or exceeds a total hop count value (Step S121). As shown in FIG. 3, when obtaining the data frame 41, any one network device first analyzes the hop count value included in the data frame, and compares the hop count value with the total hop count value, so as to judge whether the same data frame 41 is obtained twice in one transmission process of the data frame 41, so as to avoid data loop transfer.

When it is judged that the frame hop count value reaches the total hop count value, that is, representing that the data loop transfer already occurs, a network device for receiving the data frame 41 discards the data frame (Step S122).

When it is judged that the frame hop count value does not reach the total hop count value, the network device for receiving the data frame 41 analyzes the data frame to update the MAC table data (Step S130).

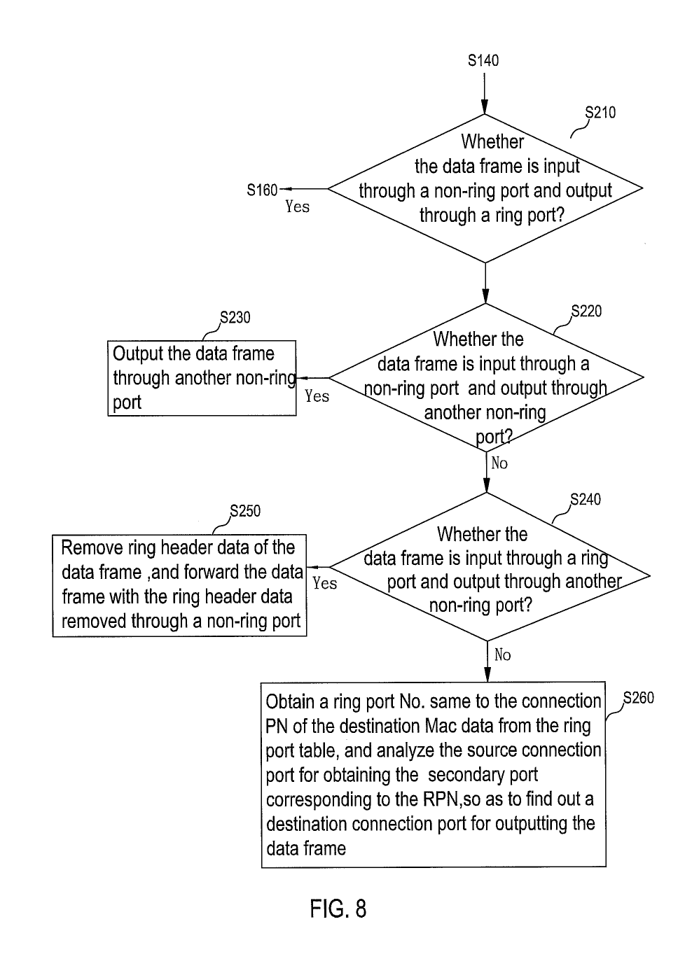

Referring to FIG. 8 at the same time, FIG. 8 is a detailed flow chart according to an embodiment of the present invention, illustrates a detailed process between (Step S140) and (Step S160), and mainly illustrates various cases of the type of the connection port for receiving the data frame and the type of the connection port specified for outputting, which includes the following steps.

It is judged whether a data frame is obtained by a source connection port conforming to a non-ring port type and forwarded to a network with an architecture of ring type (Step S210).

When the data frame is obtained through the source connection port conforming to the non-ring port type and forwarded to the network, (Step S160) is executed. This mode is the first case of receiving and sending the data frame: input through the non-ring port, and output through the ring port output. Taking the architecture depicted in FIG. 3 as an example, the second network device 320 is regarded as a working network device, and obtains the data frame 41 from the first electronic device 210 through the connection port 328, and the second network device 320 judges that the data frame 41 needs to be forwarded through the connection port 321 or the connection port 322 in the ring port type. Otherwise, it is judged whether the data frame 41 is obtained by the source connection port conforming to the non-ring port type and forwarded to a destination connection port in the non-ring port type (Step S220). For example, the data frame 41 is transmitted to the third electronic device 230 through the connection port 329 in the non-ring port type.

When the data frame is obtained through the source connection port conforming to the non-ring port type and forwarded to the destination connection port of the non-ring port type, it is the second case of receiving and sending the data frame: input through the non-ring port, and output through the non-ring port. At this time, the data frame is output by a destination connection port of the destination path data conforming to the non-ring port type (Step S230). Otherwise, it is judged whether a destination MAC address information of the data frame does not point to the network and whether the corresponding source path data conforms to the ring port type (Step S240).

When it is judged that the destination MAC address information of the data frame does not point to the network and the corresponding source path data conforms to the ring port type, this mode is the third case of receiving and sending the data frame: input through the ring port, and output the non-ring port. At this time, ring header data of the data frame is removed, and the data frame with the ring header data removed is forwarded through a relevant connection port having the non-ring port type (Step S250).

When it is judged that the data frame is obtained through the source connection port conforming to the ring port type and forwarded to the network, this mode is the fourth case of receiving and sending the data frame: input through the ring port and output through the ring port. At this time, a ring port number same to the connection port number of the destination MAC address information is obtained from the ring port table data, and the primary port and the secondary port corresponding to the source connection port for obtaining the data frame and the ring port number are analyzed, so as to find out a destination connection port for outputting the data frame (Step S260).

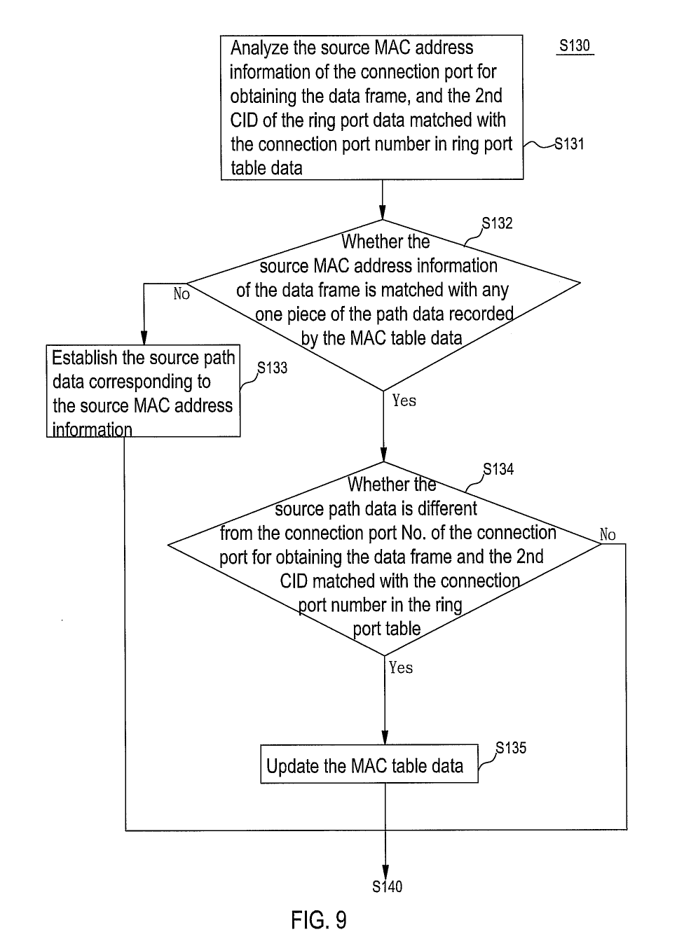

Referring to FIG. 9 at the same time, FIG. 9 is a flow chart of MAC table data update according to an embodiment of the present invention, and this method further illustrates Step S130, which includes the following steps.

The source MAC address information of the data frame, the connection port number of the connection port for obtaining the data frame, and the second identification of the ring port information matched with the connection port number in the ring port table data are analyzed (Step S131), and then it is judged whether the source MAC address information of the data frame is matched with any one path data of the MAC table data (Step S132), so as to decide whether to update the MAC table data.

When it is judged that a source path data conforming to the source MAC address information does not exist, the source path data corresponding to the source MAC address information is established (Step S133).

Otherwise, it is judged whether a data difference exists between the source path data and either the connection port number of the connection port for obtaining the data frame or the second identification matched with the connection port number in the ring port table data (Step S134).

When the source path data conforming to the source MAC address information exists, but the data difference exists between either the connection port number of the ring port for obtaining the data frame or the second identification matched with the connection port number in the ring port table data and the source path data, the MAC table data is updated (Step S135).

After a process of Step S130 ends, Step S140 is performed.

In conclusion, only implementation manners of technical solutions or the embodiments adopted by the present invention for solving the problems are recorded, and are not used to limit the patent implementation scope of the present invention. That is, all equivalent changes and modifications conforming to the meaning of the claims of the present invention or made according to the scope of the present invention fall within the scope of the present invention.

What is claimed is:

1. A network device for establishing path data, connected to a network with an architecture of ring type and receiving and sending a data frame, comprising:
a memory unit, recorded with a MAC table data and a ring port table data, wherein the MAC table data comprises at least one path data, each path data comprises a device MAC address information and a first identification, the ring port table data comprises a ring port information corresponding to the network, wherein the ring port information comprises a ring port number, information of a primary port and information of a secondary port corresponding to the ring port number and connected to the network, and a second identification; and
a processing unit, adjusting the corresponding second identification when path interruption of the network is detected, and analyzing whether the first identification of destination path data of the data frame is consistent with the second identification corresponding to the destination path data when the data frame is received, so as to decide an output port for the data frame.

2. The network device for establishing path data according to claim 1, wherein each ring port information further comprises a port status value corresponding to a connection status of the network, and when a path of the network is interrupted, the processing unit changes the port status value from a ring network value to a line network value and adjusts the second identification.

3. The network device for establishing path data according to claim 2, wherein the processing unit performs a judgment process of whether the port status value is the ring network value or the line network value when the processing unit judges that the data frame is obtained by a source connection port conforming to a non-ring port type, and the data frame is to be output through the primary port or the secondary port.

4. The network device for establishing path data according to claim 1, wherein the memory unit is further recorded with a total hop count value corresponding to a network device connection quantity of the network, the path data further comprises an hop count value corresponding to the device MAC address information, and the processing unit further decides the output port for the data frame according to whether the hop count value reaches or exceeds half of the total hop count value.

5. The network device for establishing path data according to claim 4, wherein the data frame is output through the primary port when the processing unit judges that the hop count value does not reach or not exceed half of the total hop count value, and the data frame is output through the secondary port when the processing unit judges that the hop count value reaches or exceeds half of the total hop count value.

6. The network device for establishing path data according to claim 4, wherein the data frame is output through the secondary port when the processing unit judges that the hop count value does not reach or not exceed half of the total hop count value, and the data frame is output through the primary port when the processing unit judges that the hop count value reaches or exceeds half of the total hop count value.

7. The network device for establishing path data according to claim 4, wherein the data frame is discarded when the processing unit judges that the hop count value reaches the total hop count value.

8. The network device for establishing path data according to claim 1, wherein the data frame is output by the secondary port when the processing unit judges that the primary port is a source connection port for receiving the data frame.

9. The network device for establishing path data according to claim 1, wherein the data frame is output by the primary port when the processing unit judges that the secondary port is a source connection port for receiving the data frame.

10. The network device for establishing path data according to claim 1, wherein the processing unit further analyzes whether the second identification is matched with the path data, so as to decide whether to update the MAC table data.

11. The network device for establishing path data according to claim 1, wherein a flooding process is performed when the processing unit judges that a destination MAC address information of the data frame does not conform to the at least one path data of the MAC table data.

12. A method for establishing path data of a network device, wherein the network device is connected to a network with an architecture of ring type and receives and sends a data frame, and the method comprises:
establishing a MAC table data and a ring port table data, wherein the MAC table data comprises at least one path data, each path data comprises a first identification, and the ring port table data comprises a ring port information, wherein the ring port information comprises a second identification; and
when judging that the network is interrupted, analyzing whether the first identification of destination path data of the data frame is consistent with the second identification of the ring port information corresponding to the destination path data, so as to decide an output port for the data frame.

13. The method for establishing path data of the network device according to claim 12, wherein the network device further records a total hop count value, each path data further comprises a hop count value corresponding to a device MAC address information, and the method further comprises:
judging whether the network is interrupted;
when judging that the network is not interrupted, obtaining the hop count value of a destination MAC address information according to the device MAC address information of each path data corresponding to a destination MAC address information of the data frame;
judging whether the hop count value reaches or exceeds half of the total hop count value; and
when the hop count value does not reach or not exceed half of the total hop count value, forwarding the data frame from a primary port corresponding to a ring port number of the ring port information matched with the destination path data.

14. The method for establishing path data of the network device according to claim 13, further comprising:
when judging that the hop count value reaches or exceeds half of the total hop count value, forwarding the data frame from a secondary port corresponding to the destination path data.

15. The method for establishing path data of the network device according to claim 13, further comprising:
judging whether the data frame is obtained by a source connection port conforming to a non-ring port type and forwarded to the network; and
when judging that the destination MAC address information of the data frame does not point to the network and is not obtained by the source connection port conforming to the non-ring port type, outputting the data frame by a destination connection port of the destination path data of the non-ring port type.

16. The method for establishing path data of the network device according to claim 15, wherein the judging whether the data frame is obtained by the source connection port conforming to the non-ring port type and forwarded to the network further comprises:
when judging that the data frame is obtained by the source connection port conforming to a ring port type and forwarded to the network, obtaining the ring port number same to a connection port number of the destination MAC address information from the ring port table data, and analyzing the source connection port for obtaining the data frame, and the primary port and a secondary port corresponding to the ring port number, so as to find out a destination connection port for outputting the data frame.

17. The method for establishing path data of the network device according to claim 16, further comprising:
when source path data corresponding to a ring port for obtaining the data frame exists, and the first identification is different from the second identification corresponding to the source path data, updating the MAC table data.

18. The method for establishing path data of the network device according to claim 16, further comprising:
when source path data conforming to a source MAC address information of the data frame does not exist, establishing the source path data corresponding to the data frame.

19. The method for establishing path data of the network device according to claim 13, further comprising:
when the destination path data conforming to the destination MAC address information of the data frame does not exist in the MAC table data, a flooding process is performed.

20. The method for establishing path data of the network device according to claim 13, further comprising:
when it is judged that a frame hop count value of the data frame reaches the total hop count value, the data frame is discarded.
